(19) United States
(12) Patent Application Publication
(10) Pub. No.: US 2014/0058696 A1
(43) Pub. Date: Feb. 27, 2014

(54) APPARATUS AND METHOD FOR CONTROLLING GAIN AUTOMATICALLY IN INERTIA SENSOR

(71) Applicant: SAMSUNG ELECTRO-MECHANICS CO., LTD., Suwon (KR)

(72) Inventors: Byoung Won Hwang, Suwon (KR); Kyung Rin Kim, Suwon (KR); Chang Hyun Kim, Suwon (KR)

(73) Assignee: SAMSUNG ELECTRO-MECHANICS CO., LTD., Suwon (KR)

(21) Appl. No.: 13/861,180

(22) Filed: Apr. 11, 2013

(30) Foreign Application Priority Data
Aug. 24, 2012 (KR) 10-2012-0093180

(51) Int. Cl. G01P 21/00

(52) U.S. Cl. CPC G01P 21/00
USPC 702/104

(57) ABSTRACT

Disclosed herein are an apparatus and a method for controlling a gain automatically in an inertia sensor. The apparatus for controlling a gain automatically in an inertia sensor includes: an inertia sensor detecting an acceleration and angular velocity of a corresponding shaft by vibration and Coriolis force of a driving mass for each shaft; a driving unit vibrating the driving mass toward the corresponding shaft by applied driving voltage; a detection unit detecting driving displacement of the driving mass which vibrates by the driving unit; and a control unit comparing the detected driving displacement with a predetermined target value to judge a state of the driving mass and when a state of the driving mass is abnormal, and controlling the driving displacement of the driving mass to be compensated, and as a result, accuracy can be improved, and damage of the driving mass and driving noise can be minimized.

### CROSS REFERENCE TO RELATED APPLICATION

This application claims the benefit of Korean Patent Application No. 10-2012-0093180, filed on Aug. 24, 2012, entitled “Apparatus and Method for Controlling Gain Automatically in Inertia Sensor”, which is hereby incorporated by reference in its entirety into this application.

### BACKGROUND OF THE INVENTION

1. Technical Field

The present invention relates to an apparatus and a method for controlling a gain automatically in an inertia sensor.

2. Description of the Related Art

An inertia sensor is used as various purposes such as a motion sensing purpose, a navigation purpose, and the like of an air bag, electronic stability control (ESC), a vehicular black box, a hand-shake preventing camcorder, a cellular phone, and a game machine from a military purpose such as a satellite, a missile, an unmanned aerial vehicle, and the like.

The inertia sensor is divided into an acceleration sensor capable of measuring a linear motion and an angular velocity sensor capable of measuring a rotary motion.

Acceleration can be acquired by Newton's law of motion “F=ma’, and as a result, “m” represents the mass of a moving object and “a” represents acceleration to be measured. The angular velocity can be acquire by “F=2mΩv” associated with Coriolis force, and herein, “m” represents the mass of the moving object, Ω represents the angular velocity to be measured, and “v” represents a motion velocity of the mass. The direction of Coriolis force is determined by a velocity (v) shaft and a rotational shaft of the angular velocity Ω.

The inertia sensor performs an automatic gain control to maintain constant performance regardless of a change in time or surrounding environment for accurately sensing a target signal.

In the case of the automatic gain control, a signal level at a previous stage is sensed when it is impossible to deal with fluctuation of an input signal in sensing a signal level for automatic gain control in an output of the apparatus, for example, fluctuation in purposed-except signal, when a to purpose-except signal level is higher than a purpose signal level, or the like based on a method of controlling a gain of an automatic gain controlling apparatus according to a general output level, and the like to thereby solve a problem.

However, the automatic gain control in the inertia sensor in the related art is performed by using a response characteristic of the signal level and it is impossible or inefficient to sense a gain loss due to deterioration or damage of the inertial sensor itself.

Accordingly, an apparatus and a method for controlling a gain automatically in an inertia sensor have come to the fore, which are capable of compensating for the gain loss by physical damage of the inertia sensor or a defect of the inertia sensor itself depending on the change in time or environment.

### PRIOR ART DOCUMENT

### Patent Document

[Patent Document 1] Korean Patent Registration No. 10-1171522

### SUMMARY OF THE INVENTION

The present invention has been made in an effort to provide an apparatus and a method for controlling a gain automatically in an inertia sensor that compensate for driving displacement of a driving mass by automatically performing an AGC so that driving displacement of the driving mass of the inertia sensor is constantly driven regardless of a time and an environment (temperature).

Further, the present invention has been made in an effort to provide an apparatus and a method for controlling a gain automatically in an inertia sensor that shorten an initial stabilization time, minimize damage of the driving mass, and minimize driving noise of the driving mass through an AGC by setting initial driving voltage, a margin value to a target value, a driving voltage range, and the like.

According to a first preferred embodiment of the present invention, there is provided an apparatus for controlling a gain automatically in an inertia sensor, including: an inertia sensor detecting an acceleration and angular velocity of a corresponding shaft by vibration and Coriolis force of a driving mass for each shaft; a driving unit vibrating the driving mass toward the corresponding shaft by applied driving voltage; a detection unit detecting driving displacement of the driving mass which vibrates by the driving unit; and a control unit comparing the detected driving displacement with a predetermined target value to judge a state of the driving mass and when a state of the driving mass is abnormal, and controlling the driving displacement of the driving mass to be compensated.

The control unit may calculate a difference between the detected driving displacement and the target value to judge that the state of the driving mass is normal when the difference is within the range of a margin value and judge that the state of the driving mass is abnormal when the difference is not within the range of the margin value.

The control unit may include an automatic gain control (AGC) that calculates driving voltage corresponding to a difference between the detected driving displacement and the target value and applies the driving voltage reset to the calculated driving voltage to the driving unit when the state of the driving mass is abnormal.

The automatic gain control (AGC) of the control unit may judge whether the reset driving voltage is within a driving voltage range of the driving unit to judge whether the reset driving voltage is lower than predetermined minimum driving voltage when the reset driving voltage is not in the driving voltage range.

The automatic gain control (AGC) of the control unit may set the reset driving voltage to the predetermined minimum driving voltage to apply the set voltage to the driving unit when the reset driving voltage is lower than the predetermined minimum driving voltage and judge whether the reset driving voltage is higher than predetermined maximum driving voltage when the reset driving voltage is not lower than the predetermined minimum driving voltage.

The automatic gain control (AGC) of the control unit may set the reset driving voltage to the predetermined maximum driving voltage to apply the set voltage to the driving unit when the reset driving voltage is higher than the predetermined maximum driving voltage and recalculate and set the reset driving voltage when the reset driving voltage is not higher than the predetermined maximum driving voltage.

The automatic gain control (AGC) of the control unit may set the reset driving voltage to predetermined initial driving voltage to apply the set voltage to the driving unit when the reset driving voltage is not higher than predetermined maximum driving voltage.

The apparatus may further include an A/D conversion unit converting an analog signal detected from the detection unit into a digital signal and transferring the digital signal to the control unit; and a D/A conversion unit converting the digital signal input from the control unit into the analog signal and transferring the analog signal to the driving unit.

The apparatus may further include a filter unit removing noise of the digital signal converted from the A/D conversion unit and transferring the digital signal with no noise to the control unit.

According to a second preferred embodiment of the present invention, there is provided a method for controlling a gain automatically in an inertia sensor, including: (A) vibrating a driving mass of the inertia sensor by driving voltage applied to a driving unit; (B) detecting driving displacement of the vibrating driving mass; and (C) comparing the detected driving displacement with a predetermined target value to judge a state of the driving mass and when a state of the driving to mass is abnormal, controlling the driving displacement of the driving mass to be compensated.

The method may further include setting initial driving voltage and a driving voltage range of the driving unit, the target value, and a margin value range of the target value, before step (A). The driving voltage range may be from minimum driving voltage to maximum driving voltage.

Step (B) may include (B1) comparing a sine wave-type voltage waveform of the driving mass with reference voltage; (B2) inverting the sine wave-type voltage waveform of the driving mass to have a value larger than the reference voltage and rectifying the inverted waveform to a wave-type voltage waveform when the sine wave-type voltage waveform of the driving mass is lower than the reference voltage; and (B3) integrating the rectified wave-type voltage waveform and planarizing the integrated waveform to DC-type voltage.

Step (B) may further include (B4) measuring a peak value of an amplitude of the sine wave-type voltage waveform of the driving mass during a predetermined cycle.

Step (C) may include (C1) calculating a difference between the detected driving displacement and a predetermined target value; (C2) judging whether the difference is within the range of a predetermined margin value to judge that a state of the driving mass is normal when the difference is within the range of the predetermined margin value and judge that the state of the driving mass is abnormal when the difference is not within the range of the predetermined margin value; (C3) calculating the driving voltage corresponding to the difference and resetting the driving voltage to the calculated driving voltage of the inertia sensor in order to compensate for the driving displacement of the driving mass when the state of the driving mass is abnormal; and (C4) applying the reset driving voltage to the driving unit.

The method may further include, between step (C3) and step (C4), (C5) judging whether the reset driving voltage is within the range of predetermined driving voltage; and (C6) comparing the reset driving voltage with predetermined minimum driving voltage or maximum driving voltage to reset the reset driving voltage to the corresponding driving voltage when the reset driving voltage is not within the range of the predetermined driving voltage.

Step (C6) may include (C6-1) judging whether the reset driving voltage is lower than the predetermined minimum driving voltage when the reset driving voltage is not in the predetermined driving voltage range; (C6-2) setting the reset driving voltage to the predetermined minimum driving voltage when the reset driving voltage is lower than the predetermined minimum driving voltage and judging whether the reset driving voltage is higher than the predetermined maximum driving voltage when the reset driving voltage is not lower than the predetermined minimum driving voltage; and (C6-3) setting the reset driving voltage to the predetermined maximum driving voltage when the reset driving voltage is higher than the predetermined maximum driving voltage and recalculating the reset driving voltage when the reset driving voltage is not higher than the predetermined maximum driving voltage.

Step (C6-3) may include setting the reset driving voltage to predetermined initial driving voltage when the reset driving voltage is not higher than the predetermined maximum driving voltage.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an apparatus for controlling a gain automatically in an inertia sensor according to a preferred embodiment of the present invention;

FIGS. 2A through 2C are diagram for describing one example of a method of detecting displacement of a driving mass from a detection unit illustrated in FIG. 1;

FIG. 3 is a diagram for describing another example of the method of detecting displacement of the driving mass from the detection unit illustrated in FIG. 1;

FIGS. 4A and 4B are comparison diagrams for describing an initial stabilization time of driving displacement of the driving mass depending on driving voltage applied to a driving unit illustrated in FIG. 1;

FIGS. 5A and 5B are comparison diagrams for describing driving noise of the driving mass depending on setting a margin value range of a target value of the driving displacement; and

FIG. 6 is a flowchart illustrating a method for controlling a gain automatically in an inertia sensor according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

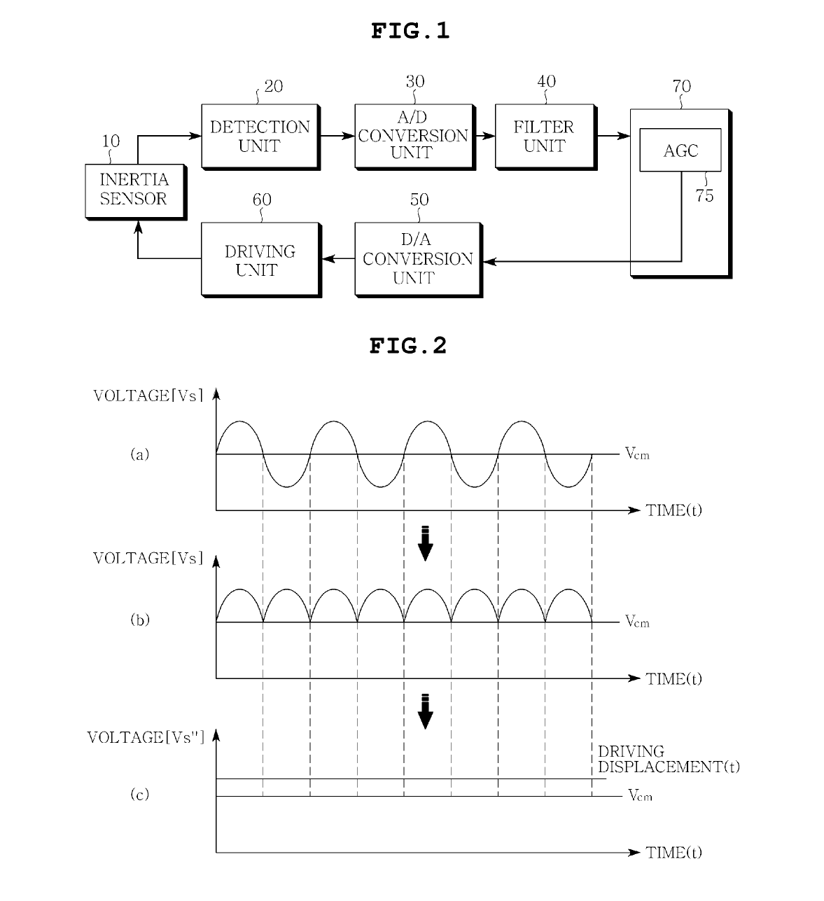

FIG. 1 is a block diagram of an apparatus for controlling a gain automatically in an inertia sensor according to a preferred embodiment of the present invention.

As illustrated in FIG. 1, the apparatus for controlling a gain automatically in an inertia sensor according to the preferred embodiment of the present invention includes an inertia sensor 10, a detection unit 20, a driving unit 60, and a control unit 70 with an AGC 75.

The inertia sensor 10 may include an acceleration sensor includes a driving mass to detect a plurality of (for example, three) shaft-direction accelerations or an angular velocity sensor capable of detecting a plurality of shaft-direction angular velocities. The inertia sensor 10 generates signals corresponding to motions such as movement and rotation, and the generated signals are transferred to the control unit 70 through the detection unit 20.

The driving unit 60 vibrates the driving mass in a direction of the corresponding shaft by applied driving voltage. In this case, predetermined driving voltage is applied to the driving unit 60 by a control in the control unit 70.

The detection unit 20 detects driving displacement which is a variation amount of movement of the driving mass which oscillates and vibrates in the inertia sensor 10 by the driving unit 60.

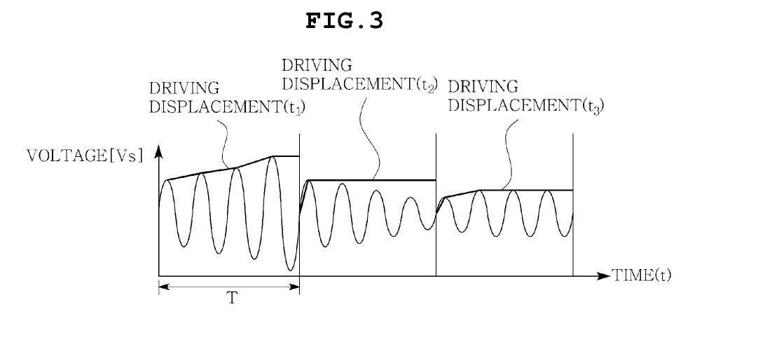

Two methods of detecting the driving displacement of the driving mass through the detection unit 20 are presented below with reference to FIGS. 2A through 2C and FIG. 3.

In detail, FIGS. 2A through 2C are diagrams for describing one example of the method of detecting displacement of the driving mass from the detection unit illustrated in FIG. 1 and FIG. 3 is a diagram for describing another example of the method of detecting the displacement of the driving mass from the detection unit illustrated in FIG. 1.

First, referring to FIGS. 2A through 2C, the detection unit 20 represents the motion of the driving mass that oscillates and vibrates by the driving voltage as a sine wave-type voltage waveform Vs based on predetermined reference voltage (for example, common mode voltage) Vcm as illustrated in FIG. 2A.

In FIG. 2A, an amplitude of the sine wave-type voltage waveform Vs is constant, but the amplitude may depend on a change in time and environment (for example, temperature).

Then, the detection unit 20 compares the sine wave-type voltage waveform Vs with the reference voltage Vcm.

In this case, when the sine wave-type voltage waveform Vs is lower than the reference voltage Vcm, to the reference voltage Vcm may be represented as a (−) signal and when the sine wave-type voltage waveform Vs is higher than the reference voltage Vcm, the reference voltage Vcm may be represented as a (+) signal.

As such, when the sine wave-type voltage waveform Vs is lower than the reference voltage Vcm (that is, in the case of the (−) signal), the sine wave-type voltage waveform Vs is inverted to have the value (that is, the (+) signal) higher than the reference voltage, which is rectified to a wave-type voltage waveform Vs′ as illustrated in FIG. 2B.

Thereafter, the detection unit 20 integrates the wave-type voltage waveform Vs′ and planarizes the integrated waveform to DC-type voltage Vs″ as illustrated in FIG. 2C.

In the above manner, the detection unit 20 detects the planarized DC-type voltage Vs″ as the driving displacement of the driving mass.

Next, referring to FIG. 3, the detection unit 20 represents the motion of the driving mass which oscillates and vibrates by the diving voltage as the sine wave-type voltage waveform Vs based on the predetermined reference voltage similarly as FIG. 2A, but the sine wave-type voltage waveform Vs which varies for each predetermined cycle T is illustrated.

In this case, the detection unit 20 allows the driving displacement of the driving mass to follow a peak value of the amplitude of the sine wave-type voltage waveform Vs. The peak value of the amplitude of the sine wave-type voltage waveform Vs becomes driving displacement t₁ driving displacement t₂, and driving displacement t₃ of the driving mass during the predetermined cycle T.

Even when the peak value of the amplitude of the sine wave-type voltage waveform Vs gradually decreases during the predetermined cycle T as illustrated in a second cycle illustrated in FIG. 3, the driving displacement t₂ of the driving mass is detected by using the peak value of the amplitude of the sine wave-type voltage waveform Vs at the corresponding cycle as the driving displacement t₂ during the corresponding cycle.

In the present invention, the detection unit 20 presents the two methods for detecting the driving displacement of the driving mass, but the driving displacement is not limited thereto and the driving displacement may be measured by various methods.

The control unit 70 totally controls the apparatus for controlling a gain automatically in the inertia sensor according to the preferred embodiment of the present invention.

In particular, the control unit 70 performs the automatic gain control (AGC) of the driving displacement so as to prevent the driving displacement of the driving mass from being changed because a state of the driving mass may be changed, that is, because the driving displacement of the driving mass may be changed according to the change in time and environment (in particular, temperature).

To this end, the control unit 70 compares the driving displacement detected through the detection unit 20 with predetermined displacement to judge the state of the driving mass and when to the state of the driving mass is abnormal, the control unit 70 includes an automatic gain control (AGC) 75 to compensate for the driving displacement of the driving mass.

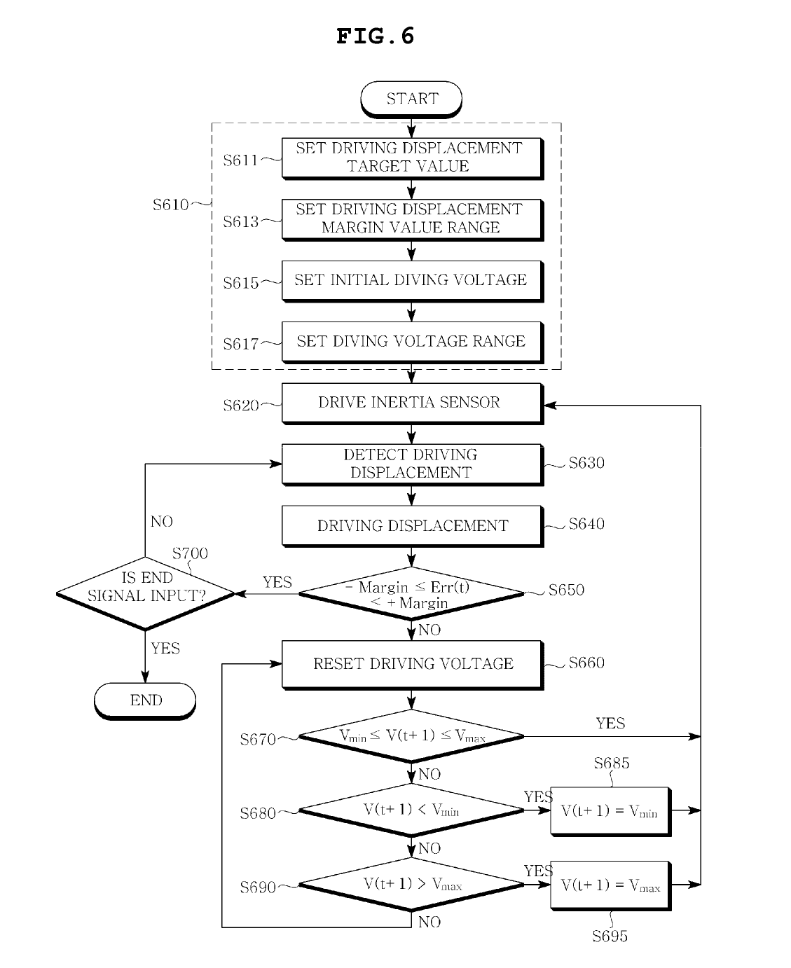

The automatic again control (AGC) of the control unit 70 will be described below in more detail with reference to FIG. 6.

Meanwhile, the driving displacement of the driving mass detected through the detection unit 20 is stabilized to a predetermined value for a predetermined stabilization time when the predetermined driving voltage is applied to the driving unit 60.

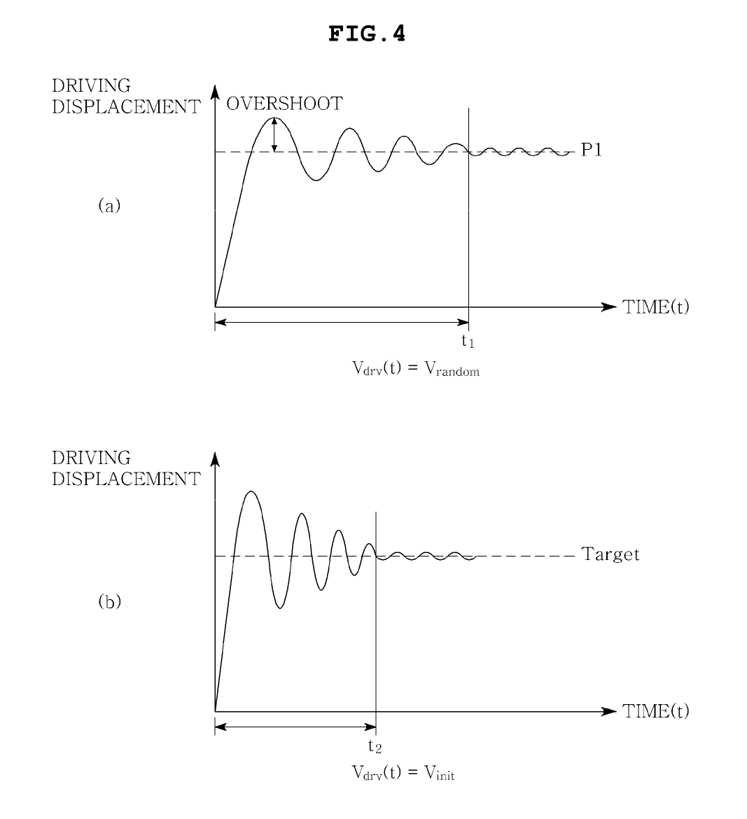

FIGS. 4A and 4B are comparison diagrams for describing an initial stabilization time of driving displacement of the driving mass depending on driving voltage applied to a driving unit illustrated in FIG. 1.

Referring to FIG. 4A, when predetermined driving voltage V_{drv}(t)=V_{random} is applied to the driving unit 60, the driving voltage is stabilized to predetermined driving displacement P1 as time elapsed. In this case, a time (hereinafter, referred to as a ‘stabilization time’) when the driving voltage is stabilized to the driving displacement P1 is t1.

Herein, since the driving displacement P1 at the predetermined driving voltage V_{random} may be larger or smaller than a target value, the control unit 70 (in detail, the AGC 75) compares the predetermined driving voltage V_{random} with the target value to calculate a difference therebetween and reflects reset driving voltage so as to compensate for the driving displacement as large as the calculated difference and applies the reflected driving voltage to the driving unit 60 again.

In this manner, the AGC 75 of the control unit 70 needs to repeat the process illustrated in FIG. 4A until the driving displacement of the driving mass corresponds to the target value while the driving voltage V_{drv} to be applied to the driving unit 60 varies to a predetermined increase value until the driving displacement of the driving mass has the target value.

In this case, the AGC 75 of the control unit 70 needs a stabilization time of a predetermined time illustrated in FIG. 4A every driving voltage V_{drv} of every increase value for AGC of the driving displacement and after stabilization, compares the corresponding stabilization value with the target value to judge whether the stabilization value of the corresponding driving voltage reaches the target value, a long time is required.

Therefore, in the present invention, as illustrated in FIG. 4B, the driving voltage V_{drv} equivalent to the target value is calculated through a predetermined algorithm to set the corresponding driving voltage V_{drv} as initial driving voltage Vᵢₙₜ.

The process which needs to be repeated until the driving displacement of the driving mass reaches the target value is minimized and resulting every stabilization time is not needed, thereby shortening an AGC time.

When the initial driving voltage Vᵢₙₜ illustrated in FIG. 4B is higher than the predetermined driving voltage V_{random} illustrated in FIG. 4A, the case of FIG. 4B is much shorter than the case of FIG. 4A in terms of the stabilization time (t2<t1).

Therefore, the initial driving voltage Vᵢₙₜ is within a range not to be larger than a threshold value of overshoot and is preferably a driving voltage range which may be provided by the driving unit 60, that is, between minimum driving voltage Vₘᵢₙ and maximum driving voltage Vₘₐₓ.

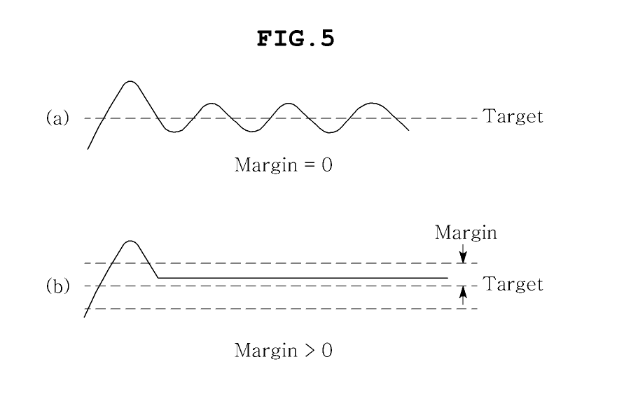

Meanwhile, the target value of the driving displacement of the driving mass preferably has a predetermined margin value range. The margin may still minimize driving noise which is an adverse effect at the time of performing the AGC of the driving displacement of the driving mass and will be described with reference to FIGS. 5A and 5B.

FIGS. 5A and 5B are comparison diagrams for describing driving noise of the driving mass depending on setting a margin value range of a target value of the driving displacement.

FIG. 5A is an enlarged diagram of part A illustrated in FIG. 4B and it can be seen that the driving displacement of the driving mass continuously oscillates around the target value.

In this case, when the margin is not present in the target value, excessive driving noise is generated due to the driving displacement which oscillates at the time of calculating the difference between the detected driving displacement and the target value at the time of performing the AGC of the driving displacement of the driving mass, in the AGC 75 of the control unit 70, which may cause an excessive burden to an entire AGC system.

Therefore, in order to minimize the driving noise caused due to the driving displacement which oscillates at the time of performing the AGC of the driving displacement, the margin value is present around the target value as illustrated in FIG. 5B. The margin value may be in the range of approximately 5 to 10% of the target value.

For example, when the target value 10 and the margin value 10%, the target value may be in the range of 9 to 11. That is, the driving displacement detected through the detection unit 20 which is in the range of 9 to 11 is regarded as 10 which is the target value to be applied in the AGC.

Alternatively, a margin value is set with respect to an absolute value of the difference between the driving displacement detected through the detection unit 20 and the target value and the set margin value may be applied in the AGC.

The apparatus for controlling a gain automatically in an inertia sensor according to the preferred embodiment of the present invention may perform the AGC of the driving displacement of the driving mass more precisely by combining an analog terminal and a digital terminal.

To this end, the apparatus for controlling a gain automatically in an inertia sensor according to the preferred embodiment of the present invention may further include an A/D conversion unit 30 that converts an analog signal detected from the detection unit 20 into a digital signal and transfers the digital signal to the control unit 70, a D/A conversion unit 50 that converts the digital signal input from the control unit 70 into the analog signal and transfers the analog signal to the driving unit 60, and a filter unit 40 that removes noise of the digital signal converted from the A/D conversion unit 30 and transfers the digital signal with no noise to the control unit 70. Herein, as the filter unit 40, a low pass filter (LPF) may be used.

FIG. 6 is a flowchart illustrating a method for controlling a gain automatically in an inertia sensor according to another preferred embodiment of the present invention.

Referring to FIG. 6, the control unit 70 (in detail, the automatic gain control (AGC) 75) may set setting values required at the time of performing the AGC of the driving displacement of the driving mass by inputting the setting values by means of a predetermined input device (not illustrated) (S610).

The setting values include a target value of the driving displacement (S611), a margin value of the driving displacement (S613), initial driving voltage Vᵢₙₜ (S615), and a driving voltage range (that is, minimum driving voltage Vₘᵢₙ and maximum driving voltage Vₘₐₓ of the driving unit 60 (S617) and the values may be set in sequence.

In this case, the setting values may be, in advance, set and stored in a predetermined storage device at the time of designing the apparatus.

When inputting the setting values is completed, predetermined driving voltage is applied to the driving unit 60 and the driving mass of the inertia sensor 10 thus vibrates, and as a result, the inertia sensor 10 is driven (S620).

Then, the driving displacement of the driving mass that oscillates and vibrates by the driving voltage applied by the driving unit 60 is detected through the detection unit 20 (630).

In detail, the detection unit 20 compares the sine wave-type voltage waveform VS of the driving mass with the reference voltage Vcm and when the sine wave-type voltage waveform Vs of the driving mass is lower than the reference voltage Vcm, the detection unit 20 inverts the sine wave-type voltage waveform Vs to have a value higher than the reference voltage Vcm and rectifies the inverted waveform to a wave-type voltage waveform Vs′. Thereafter, the detection unit 20 integrates the rectified wave-type voltage waveform Vs′ and planarizes the integrated waveform to DC-type voltage Vs″ to detect driving displacement corresponding to the corresponding driving voltage.

The detection unit 20 measures a peak value of an amplitude of the sine wave-type voltage waveform Vs of the driving mass during a predetermined cycle T to detect the driving displacement corresponding to the corresponding driving voltage.

Thereafter, the AGC 75 of the control unit 70 compares the driving displacement detected from the detection unit 20 with a predetermined target value to judge a state of the driving mass (S650).

In detail, the AGC 75 of the control unit 70 calculates a difference (hereinafter, referred to as Err(t)) between the detected driving displacement t and a predetermined target value Target (S640) to judge whether the difference Err(t) is in the range of a predetermined margin value (S650).

In step S650, when the difference Err(t) is in the range of the margin value, the AGC 75 of the control unit 70 judges that the state of the driving mass is normal and when the difference Err(t) is not in the range of the margin value, the AGC 75 judges that the state of the driving mass is abnormal.

As a result, when the state of the driving mass is abnormal, the driving voltage corresponding to the difference Err(t) is calculated and thereafter, the driving voltage V(t) is reset to the calculated driving voltage V(t+1) (that is, V(t) is reset to V(t+1) in order to compensate for the driving displacement of the driving mass (S660).

In this case, the AGC 75 of the control unit 70 may further judge whether the reset driving voltage V(t+1) is within a predetermined driving voltage range (that is, from the minimum driving voltage Vₘᵢₙ and the maximum driving voltage Vₘₐₓ) which may be provided by the driving unit 60 in order to minimize damage of the driving mass (S670).

In step S670, when the reset driving voltage V(t+1) is within the predetermined driving voltage range, the corresponding reset driving voltage V(t+1) is applied to the driving unit 60 to drive the inertia sensor 10.

However, step S670 may further include comparing the reset driving voltage V(t+1) with the predetermined minimum driving voltage Vₘᵢₙ or maximum driving voltage Vₘₐₓ and resetting the reset driving voltage to the corresponding driving voltage when the reset driving voltage V(t+1) is not in the predetermined driving voltage range (S680 and S690).

In detail, in step S670, when the reset driving voltage V(t+1) is not in the driving voltage range, the AGC 75 of the control unit 70 judges whether the reset driving voltage V(t+1) is lower than the predetermined minimum driving voltage Vₘᵢₙ (S680).

In step S680, when the reset driving voltage V(t+1) is lower than the predetermined minimum driving voltage Vₘᵢₙ, the AGC 75 of the control unit 70 sets the reset driving voltage V(t+1) to the predetermined minimum driving voltage Vₘᵢₙ (S685) and applies the set voltage to the driving unit 60 to drive the inertia sensor 10.

Meanwhile, in step S680, when the reset driving voltage V(t+1) is not lower than the predetermined minimum driving voltage Vₘᵢₙ, the AGC 75 of the control unit 70 judges whether the reset driving voltage V(t+1) is higher than the predetermined maximum driving voltage Vₘₐₓ (S690).

In step S690, when the reset driving voltage V(t+1) is higher than the predetermined maximum driving voltage Vₘₐₓ, the AGC 75 of the control unit 70 sets the reset driving voltage V(t+1) to the predetermined maximum driving voltage Vₘₐₓ (S695) and applies the set voltage to the driving unit 60 to drive the inertia sensor 10.

Meanwhile, in step S690, when the reset driving voltage V(t+1) is not higher than the predetermined maximum driving voltage Vₘₐₓ, the AGC 75 of the control unit 70 returns to step S660 to recalculate the reset driving voltage V(t+1) and repeats a subsequent process.

Alternatively, although not illustrated, in step S690, when the reset driving voltage V(t+1) is not higher than the predetermined maximum driving voltage Vₘₐₓ, the AGC 75 of the control unit 70 resets the reset driving voltage V(t+1) to predetermined initial driving voltage Vᵢₙₜ and applies the set voltage to the driving unit 60 to drive the inertia sensor 10.

Meanwhile, in step S650, when the difference Err(t) is within the range of the margin value, the AGC 75 of the control unit 70 may further judge whether an end signal is input (S700).

In step S700, when the end signal is input, the AGC 75 of the control unit 70 ends the automatic gain control (AGC) of the inertia sensor 10 of the present invention and when the end signal is not input, the process returns to step S630 to repeat a subsequent process.

According to the preferred embodiments of the present invention, the driving mass is constantly driven regardless of a change in time and environment (temperature) by compensating for the driving displacement of the driving mass of the inertia sensor and performing the AGC to thereby improve accuracy.

The initial stabilization time can be shortened by setting the initial driving voltage for driving the driving mass and the damage of the inertia sensor can be minimized by setting the driving voltage range for driving the driving mass.

Further, the driving noise of the driving mass by the AGC can be minimized by setting a margin value of a target value at the time of performing the AGC of the driving mass.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus for controlling a gain automatically in an inertia sensor, comprising:
an inertia sensor detecting an acceleration and angular velocity of a corresponding shaft by vibration and Coriolis force of a driving mass for each shaft;
a driving unit vibrating the driving mass toward the corresponding shaft by applied driving voltage;
a detection unit detecting driving displacement of the driving mass which vibrates by the driving unit; and
a control unit comparing the detected driving displacement with a predetermined target value to judge a state of the driving mass and when a state of the driving mass is abnormal, and controlling the driving displacement of the driving mass to be compensated.

2. The apparatus as set forth in claim 1, wherein the control unit calculates a difference between the detected driving displacement and the target value to judge that the state of the driving mass is normal when the difference is within the range of a margin value and judge that the state of the driving mass is abnormal when the difference is not within the range of the margin value.

3. The apparatus as set forth in claim 1, wherein the control unit includes an automatic gain control (AGC) that calculates driving voltage corresponding to a difference between the detected driving displacement and the target value and applies the driving voltage reset to the calculated driving voltage to the driving unit when the state of the driving mass is abnormal.

4. The apparatus as set forth in claim 3, wherein the automatic gain control (AGC) of the control unit judges whether the reset driving voltage is within a driving voltage range of the driving unit to judge whether the reset driving voltage is lower than predetermined minimum driving voltage when the reset driving voltage is not in the driving voltage range.

5. The apparatus as set forth in claim 4, wherein the automatic gain control (AGC) of the control unit sets the reset driving voltage to the predetermined minimum driving voltage to apply the set voltage to the driving unit when the reset driving voltage is lower than the predetermined minimum driving voltage and judges whether the reset driving voltage is higher than predetermined maximum driving voltage when the reset driving voltage is not lower than the predetermined minimum driving voltage.

6. The apparatus as set forth in claim 5, wherein the automatic gain control (AGC) of the control unit sets the reset driving voltage to the predetermined maximum driving voltage to apply the set voltage to the driving unit when the reset driving voltage is higher than the predetermined maximum driving voltage and recalculates and sets the reset driving voltage when the reset driving voltage is not higher than the predetermined maximum driving voltage.

7. The apparatus as set forth in claim 6, wherein the automatic gain control (AGC) of the control unit sets the reset driving voltage to predetermined initial driving voltage to apply the set voltage to the driving unit when the reset driving voltage is not higher than predetermined maximum driving voltage.

8. The apparatus as set forth in claim 1, further comprising:
an A/D conversion unit converting an analog signal detected from the detection unit into a digital signal and transferring the digital signal to the control unit; and
a D/A conversion unit converting the digital signal input from the control unit into the analog signal and transferring the analog signal to the driving unit.

9. The apparatus as set forth in claim 8, further comprising:
a filter unit removing noise of the digital signal converted from the A/D conversion unit and transferring the digital signal with no noise to the control unit.

10. A method for controlling a gain automatically in an inertia sensor, the method comprising:
(A) vibrating a driving mass of the inertia sensor by driving voltage applied to a driving unit;
(B) detecting driving displacement of the vibrating driving mass; and
(C) comparing the detected driving displacement with a predetermined target value to judge a state of the driving mass and when a state of the driving mass is abnormal, controlling the driving displacement of the driving mass to be compensated.

11. The method as set forth in claim 10, further comprising:
setting initial driving voltage and a driving voltage range of the driving unit, the target value, and a margin value range of the target value, before step (A).

12. The method as set forth in claim 11, wherein the driving voltage range is from minimum driving voltage to maximum driving voltage.

13. The method as set forth in claim 10, wherein step (B) includes:
(B1) comparing a sine wave-type voltage waveform of the driving mass with reference voltage;
(B2) inverting the sine wave-type voltage waveform of the driving mass to have a value larger than the reference voltage and rectifying the inverted waveform to a wave-type voltage waveform when the sine wave-type voltage waveform of the driving mass is lower than the reference voltage; and
(B3) integrating the rectified wave-type voltage waveform and planarizing the integrated waveform to DC-type voltage.

14. The method as set forth in claim 10, wherein step (B) further includes (B4) measuring a peak value of an amplitude of the sine wave-type voltage waveform of the driving mass during a predetermined cycle.

15. The method as set forth in claim 10, wherein step (C) includes:
(C1) calculating a difference between the detected driving displacement and a predetermined target value;
(C2) judging whether the difference is within the range of a predetermined margin value to judge that a state of the driving mass is normal when the difference is within the range of the predetermined margin value and judge that the state of the driving mass is abnormal when the difference is not within the range of the predetermined margin value;
(C3) calculating the driving voltage corresponding to the difference and resetting the driving voltage to the calculated driving voltage of the inertia sensor in order to compensate for the driving displacement of the driving mass when the state of the driving mass is abnormal; and
(C4) applying the reset driving voltage to the driving unit.

16. The method as set forth in claim 15, further comprising:
between step (C3) and step (C4),
(C5) judging whether the reset driving voltage is within the range of predetermined driving voltage; and
(C6) comparing the reset driving voltage with predetermined minimum driving voltage or maximum driving voltage to reset the reset driving voltage to the corresponding driving voltage when the reset driving voltage is not within the range of the predetermined driving voltage.

17. The method as set forth in claim 16, wherein step (C6) includes:
(C6-1) judging whether the reset driving voltage is lower than the predetermined minimum driving voltage when the reset driving voltage is not in the predetermined driving voltage range;
(C6-2) setting the reset driving voltage to the predetermined minimum driving voltage when the reset driving voltage is lower than the predetermined minimum driving voltage and judging whether the reset driving voltage is higher than the predetermined maximum driving voltage when the reset driving voltage is not lower than the predetermined minimum driving voltage; and
(C6-3) setting the reset driving voltage to the predetermined maximum driving voltage when the reset driving voltage is higher than the predetermined maximum driving voltage and recalculating the reset driving voltage when the reset driving voltage is not higher than the predetermined maximum driving voltage.

18. The method as set forth in claim 17, wherein step (C6-3) includes setting the reset driving voltage to predetermined initial driving voltage when the reset driving voltage is not higher than the predetermined maximum driving voltage.
